(19) United States
(12) Patent Application Publication
(10) Pub. No.: US 2024/0316752 A1
(43) Pub. Date: Sep. 26, 2024

(54) Slide Rod Swivel Hook Rack

(71) Applicant: Mark F Corgan, Annandale, NJ (US)

(72) Inventor: Mark F Corgan, Annandale, NJ (US)

(21) Appl. No.: 18/617,525

(22) Filed: Mar. 26, 2024

(51) Int. Cl. B25H 3/04

(52) U.S. Cl. CPC B25H 3/04

(57) ABSTRACT

A slide rod swivel hook rack is described to include an attachment flange for wall mounting fitted with a slide rod having a removeable end cap and interior channel to accommodate a plurality of multiaxial slide ball swivel hook. The multiaxial slide ball swivel hook provides for universal directional alignment for attachment and storage of handled tools and other items that incorporate a hanging eyelet, loop, or other suitable mechanism for attachment. Attachment and removal can be accommodated regardless of the fixed alignment or adjustable orientation of the eyelet, loop, or other suitable mechanism for attachment.

### BACKGROUND OF THE INVENTION

### Field of the Invention

The present invention relates to the slide rod swivel hook rack for holding and storing handled tools and other items having an integrated hanging eyelet, loop, or other means of attachment. Items include but are not limited to tools such as brooms, mops, dusters, rakes, shovels, and other items incorporating a means of attachment along with any item suitable for direct attachment to a ring style hook such as a strapped purse, backpack, and apparel items.

### Description of Related Art

It has been observed that residential occupants and commercial proprietors will place handled cleaning tools and other items for storage in closets and corners with no regard for the efficient use of the available space nor the safety of their arrangement. Many times, the items being stored are strew about the storage area in a haphazard way creating a mobility hazard in the area combined with the inefficient use of space. This in turn leads to a high degree of risk along with recurring frustration during placement and retrieval of the items. It has been further observed that the assortment of storage racks available for sale today arrange the tools horizontally with clamp type holders and hooks, failing to effectively utilize the integrated eyelet incorporated into the handle of most cleaning tools. Furthermore, many of these racks require that tools be placed in opposite directions on the rack to avoid having the tool heads overlap thereby blocking placement and retrieval of adjacent tools on the rack. The slide rod swivel hook rack has been developed to address these shortcomings by incorporating the advantages of a multiaxial slide ball swivel hook into an easy-to-install, space-efficient single point of attachment slide rod. By doing so the slide rod swivel hook rack improves the overall effectiveness of the racking solution along with eliminating the mobility risk of cluttered storage areas thereby resulting in less frustration and greater user satisfaction.

### SUMMARY OF THE INVENTION

The present invention has been accomplished based on observed common clutter and storage area scenarios for cleaning tools and other items. It is the main object of the present invention to provide a slide rod swivel hook rack which has a simple structure for accessing these items in a way that is easy to install, space efficient and easy to use. To achieve these and other objects the present invention, the slide rod swivel hook rack comprises a slide rod fitted with an end cap and mounting flange and having an interior channel to accommodate a plurality of multiaxial slide ball swivel hooks providing universal directional alignment for attachment of items incorporating a hanging eyelet, loop, or other suitable means of attachment regardless of the alignment orientation of the attachment mechanism.

### DESCRIPTION OF THE DRAWINGS

FIG. 1 is a three-point perspective view of a slide rod swivel hook rack according to the present invention.

FIG. 2 is an exploded view of the slide rod swivel hook rack according to the present invention.

FIG. 3 is a front view of the slide rod swivel hook rack with the end cap removed.

FIG. 4 is a working view of the slide rod swivel hook rack showing application of the present invention.

### DETAILED DESCRIPTION OF THE EMBODIMENT

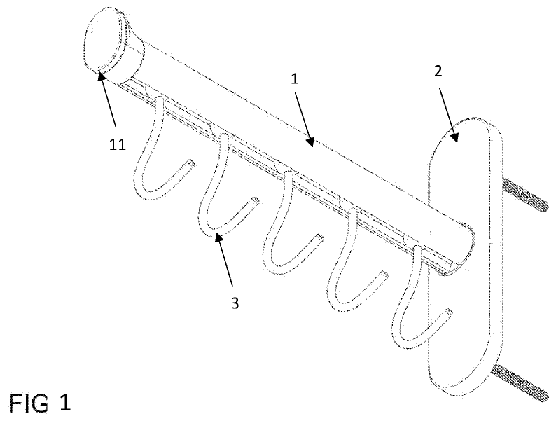

Referring to FIG. 1, a slide rod swivel hook rack in accordance with the present invention is shown comprised of a slide rod 1 with a plurality of multiaxial slide ball swivel hook 3, fitted with a mounting flange 2 and removeable endcap 11.

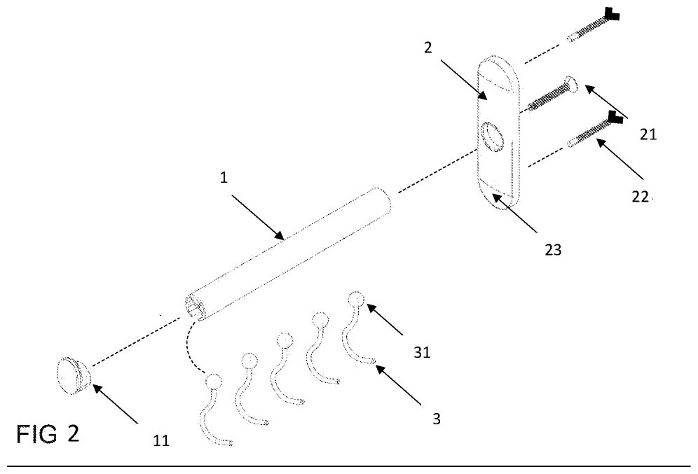

Referring to FIG. 2, slide rod 1 is connected to mounting flange 2 using flange bolt 21. The interior channel of slide rod 1 is shaped to accommodate a plurality of multiaxial slide ball swivel hook 3 all identical to multiaxial slide ball swivel hook 3. End cap 11 is inserted to slide rod 1 to close off the interior channel. The slide rod swivel hook rack is installed by attaching mounting flange 2 to any vertical surface using snap toggle anchor 22 and inserting trim cap 23 to finish. The slide rod 1 and mounting flange 2 are made of metal but can be fabricated from any suitable material including plastic or composites. The multiaxial slide ball swivel hook 3 is made of metal but can be fabricated from any suitable material including plastic or composites. The endcap 11 is made of rubber but can be fabricated from any suitable material including plastic, or composite. Trim cap 23 is made of plastic.

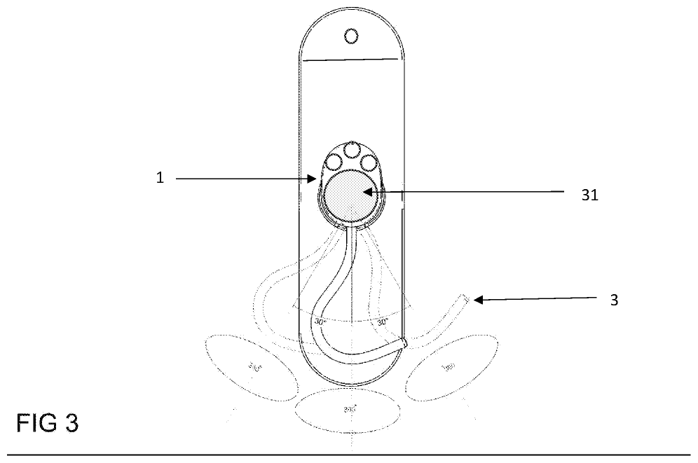

Referring to FIG. 3, showing multiaxial slide ball swivel hook 3 assembled inside the interior channel of slide rod 1 in accordance with the invention. Multiaxial slide ball swivel hook ball end 31 provides for multiaxial ball action movement to angle up to 30 degrees inside the interion channel of slide rod 1 and rotating 360 degrees and sliding laterally along the interior channel of slide rod 1. The combination of these movements provides for the exact alignment and attachment of any eyelet-ready tool handle or other items regardless of the orientation of alignment of the attachment eyelet or other attachment mechanism.

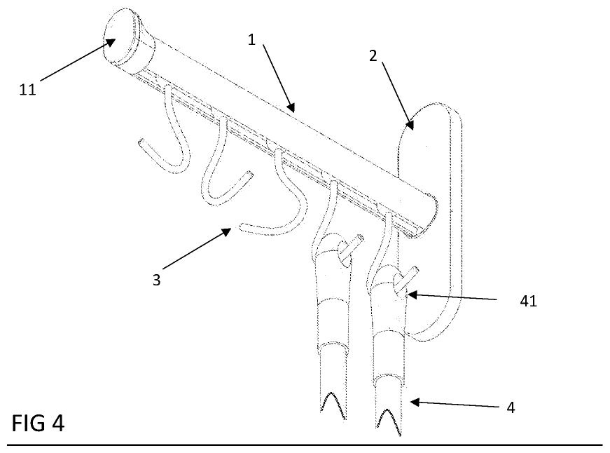

Referring to FIG. 4, a slide rod swivel hook rack assembled in accordance with the current invention, is shown comprised of a slide rod 1 with a plurality of multiaxial slide ball swivel hook 3, fitted with a mounting flange 2 and removeable endcap 11. Multiaxial slide ball swivel hook 3 is shown if various positions of alignment along with attachment of handled tool 4 containing an integrated eyelet mechanism 41.

What is claimed is:

1. A slide rod swivel hook rack comprising:
a. slide rod with interior channel to accommodate a plurality of multiaxial slide ball swivel hooks, fitted with a single mounting flange and removeable end cap.

2. The slide rod swivel hook rack as claimed in 1, where in the multiaxial slide ball swivel hook can be angled up to 30 degrees inside the interior channel of the slide rod.

3. The slide rod swivel hook rack as claimed in 1, where in the multiaxial slide ball swivel hook can rotate 360 degrees inside the interior channel of the slide rod.

4. The slide rod swivel hook rack as claimed in 1, where in the multiaxial slide ball swivel hook can slide laterally along the interior channel of the slide rod.

5. The slide rod swivel hook rack as claimed in 1, where in the combined movements of the multiaxial slide ball swivel hook inside in interior slide channel can provide universal alignment to the point of attachment.

6. The slide rod swivel hook rack as claimed in 1, where in the linear arrangement of the plurality of multiaxial slide ball swivel hook provides for unobstructed placement and retrieval of items attached to the slide rod swivel hook rack.
